(19) United States
(12) Patent Application Publication
(10) Pub. No.: US 2016/0323357 A1
(43) Pub. Date: Nov. 3, 2016

(54) FILE PUSH NOTIFICATION METHOD AND DEVICE

(71) Applicants: BEIJING KINGSOFT OFFICE SOFTWARE CO., LTD, Beijing (CN); ZHUHAI KINGSOFT OFFICE SOFTWARE CO., LTD, Zhuhai City , Guangdong (CN)

(72) Inventors: Qixu LANG, Jida Zhuhai City (CN); Borong HUANG, Jida Zhuhai City (CN)

(21) Appl. No.: 15/107,868

(22) PCT Filed: Dec. 2, 2014
(86) PCT No.: PCT/CN2014/092808

§ 371 Date: Jun. 23, 2016

(30) Foreign Application Priority Data
Dec. 27, 2013 (CN) 201310741235.1

(51) Int. Cl. H04L 29/08; G06F 17/30

(52) U.S. Cl. CPC H04L 67/06; G06F 17/30864; G06F 17/3089; H04L 67/26

(57) ABSTRACT

The present application disclosed a file push notification method and device. The method comprises: determining a file notification item set by a user which comprise a notification triggering condition and an identifier of a corresponding notification-associated file; according to the notification triggering condition, monitoring a state parameter corresponding to the notification triggering condition; when it is monitored that the state parameter meets the notification triggering condition, outputting notification information and presenting related information of the notification-associated file to the user. In the technical solution of the present application, the user is notified according to a time-based triggering condition or a geographic location-based triggering condition, and related information of the notification-associated file is presented to the user while outputting the notification information. In this manner, the user can view the related information of the content of the notification-associated file on the screen directly. Compared with the prior art, a file can be found and viewed more conveniently and rapidly, thereby effectively improving user experience.

The present application claims the priority of a Chinese patent application No. 201310741235.1, entitled “FILE PUSH NOTIFICATION METHOD AND DEVICE” and filed before the China Patent Office on Dec. 27, 2013, which is hereby incorporated into the present application by reference in its entirety.

### TECHNICAL FIELD

The present application relates to the technical field of mobile terminals, and particularly to a file push notification method and device.

### BACKGROUND

With the development of Internet and mobile intelligent technology, there are more and more functions for mobile terminals, which can carry out communications, entertainments and official affairs such that it is more convenient for people.

People's rhythms of work and life become more and more rapid with the development of society, and they need to handle lots of things every day. At first, people just write down in a notebook that something is going to be handled at somewhere and at some time. As the development of mobile intelligent technology, people only need to use the reminder function in a mobile terminal to set things to be done at some time in the future, or when arriving at a certain location, and when the set time or the set location is reached, the mobile terminal will automatically remind the user.

For example, if a user has a very important meeting at 10:30 a.m., then the user may set in a mobile terminal that the condition for triggering a notification is 10 o'clock and the content of notification is that there is a meeting at 10:30. When it is 10 o'clock, the mobile terminal will remind the user automatically and display on the screen that there is a meeting at 10:30.

Alternatively, if a user needs to buy toothpaste in a supermarket, then the user may set in a mobile terminal that the condition for triggering a notification is arriving at the supermarket and the content of notification is buying toothpaste. When the user reaches the supermarket, the mobile terminal will remind the user automatically and display “buying toothpaste” on the screen.

However, in some scenarios of life in which, for example, one needs to browse the main content of a work report before reporting, or a user needs to view a shopping list when reaching a supermarket and the like, the existing notification function can only be achieved by setting word notifications in a mobile terminal, for example, by reminding the user to browse the main content of the work report before reporting, or to view the shopping list when arriving at the supermarket. The user needs to find a corresponding file for viewing after he/she sees the notification, which is comparatively tedious, especially in case that there are many files stored in the mobile terminal and it usually takes a lot of time to find the corresponding file.

### SUMMARY

The objective of embodiments of the present application is to provide a file push notification method and device, which can remind a user and meanwhile present to the user the files that he/she needs to view.

To achieve the above objective, embodiments of the present application disclose a file push notification method and device. The technical solution is as follows.

A file push notification method includes:

determining a file notification item set by a user which comprise a notification triggering condition and an identifier of a corresponding notification-associated file;

according to the notification triggering condition, monitoring a state parameter corresponding to the notification triggering condition;

when it is monitored that the state parameter meets the notification triggering condition, outputting notification information and presenting related information of the notification-associated file to the user;

wherein the step of presenting related information of the notification-associated file to the user comprises:

presenting content of the notification-associated file to the user directly;

or,

presenting an access method of the notification-associated file to the user.

In a specific implementation of the present application, in the case in which there are a plurality of notification-associated files, the step of presenting related information of the notification-associated files to the user comprises:

presenting a list of access methods of the plurality of notification-associated files to the user.

In a specific implementation of the present application, the step of outputting notification information is: outputting at least one of vibration information, acoustic information, screen lighting information and notification information presented in a notification area of an operating system.

In a specific implementation of the present application, the notification triggering condition is a geographical location-based triggering condition or a time-based triggering condition.

A file push notification device comprises:

a notification management module used for determining a file notification item set by a user which comprise a notification triggering condition and an identifier of a corresponding notification-associated file;

a monitoring module used for, according to the notification triggering condition, monitoring a state parameter corresponding to the notification triggering condition;

a notification module used for outputting notification information and presenting related information of the notification-associated file to the user when the monitoring module monitors that the state parameter meets the notification triggering condition.

In a specific implementation of the present application, the notification module is specifically used to:

output notification information and present content of the notification-associated file to the user when the monitoring module monitors that the state parameter meets the notification triggering condition ;

or,

output notification information and present the access method of the notification-associated file to the user when the monitoring module monitors that the state parameter meets the notification triggering condition.

In a specific implementation of the present application, in the case in which there are a plurality of notification-associated files, the notification module is specifically used to:

output notification information and present a list of access methods of the plurality of notification-associated files to the user when the monitoring module monitors that the state parameter meets the notification triggering condition.

In a specific implementation of the present application, the notification information output by the notification module is at least one of vibration information, acoustic information, screen lighting information and notification information presented in a notification area of an operating system.

In a specific implementation of the present application, the notification triggering condition is a geographical location-based triggering condition or a time-based triggering condition.

Embodiments of the present application also provide an electronic device comprising:

a processor, a memory, communication interfaces and a bus;

the processor, the memory, and the communication interfaces are connected and communicating with each other via the bus;

executable program codes are stored in the memory;

the processor runs the program corresponding to the executable program codes by reading the executable program codes stored in the memory, so as to carry out any one of the file push notification methods provided by embodiments of the present application.

Embodiments of the present application also provide a storage medium which is used for storing an application program used for carrying out any one of the file push notification methods provided by embodiments of the present application.

Embodiments of the present application also provide an application program, which is used to carry out any one of the file push notification methods provided by embodiments of the present application.

In the technical solution of the present application, the user is reminded according to a time-based triggering condition or a geographic location-based triggering condition, and the related information of the notification-associated file is presented to the user while outputting the notification information. In this manner, the user can view the related information of the content of the notification-associated file on the screen directly. Compared with the prior art, the user does not need to look for the related file manually and can find the file and view the same more conveniently and rapidly, thereby effectively improving user experience.

### BRIEF DESCRIPTION OF THE DRAWINGS

In order to describe the technical solutions of embodiments of the present application and of the prior art more clearly, the drawings to be used in embodiments and prior art will be briefly introduced, obviously, the drawings described below are just for some embodiments of the present application and other drawings may be obtained by those skilled in the art without any creative effort.

FIG. 1 is a flow chart of a time-based file push notification method of the present application;

FIG. 2 is a flow chart of a geographical location-based file push notification method of the present application;

FIG. 3 is a schematic diagram of the structure of a file push notification device of the present application.

### DETAILED DESCRIPTION

Firstly, a file push notification method provided by the present application will be described, which may comprise the following steps:

determining a file notification item set by a user which comprise a notification triggering condition and an identifier of a corresponding notification-associated file;

according to the notification triggering condition, monitoring a state parameter corresponding to the notification triggering condition;

when it is monitored that the state parameter meets the notification triggering condition, outputting notification information and presenting related information of the notification-associated file to the user.

The executing subject of the above solution may be a file push notification device, which may be an independent functional entity or may also be a function module installed in the user's device. The user's device mentioned here normally refers to a mobile terminal such as a mobile phone, a tablet PC, an on-board PC, a notebook, etc, and in some cases may also be a terminal such as a desktop and so on, which is not limited in the present application.

Here, the file may be a text file, an audio file or a video file, which may be stored beforehand in a mobile terminal or may also be stored beforehand in a server at a network side.

The identifier of the notification-associated file may be the name of the file, the local path link of the file and may also be the network link of the file.

When the notification function is activated, the file push notification device receives the notification triggering condition set by a user, which may be a time-based triggering condition or a geographical location-based triggering condition.

The device also needs to receive the identifier of the notification-associated file input by the user.

After the file notification item set by the user are determined, the file push notification device automatically monitors the state parameter corresponding to the notification triggering condition set by the user; wherein, when the set notification triggering condition is time, the state parameter refers to the current time; when the set notification triggering condition is a geographical location, the state parameter refers to the coordinate of the current geographical location.

When it is monitored that the state parameter meets the notification triggering condition set by the user, the file push notification device automatically outputs the notification information which may be a vibration, a ring tone or a vibration plus a ring tone or the like, and meanwhile presents the related information of the notification-associated file to the user. The specific form of the related information may be the content of the notification-associated file, or may also be the access method of the notification-associated file; wherein the access method may be a local path or a network link. When there are a plurality of files, the file push notification device may also automatically generate a list of access methods of the notification-associated files.

The specific forms of said notification information and the related information of the notification-associated file may be determined by one skilled in the art according to practical needs.

By means of the technical solution of the present application, when receiving notification information, the user, according to his/her practical needs, may directly read the content of the notification-associated file or selectively read the notification-associated file according to the access method of the notification-associated file presented on the mobile terminal.

The technical solution of the present application will be described clearly and completely below in combination with the drawings of the present application. Obviously, the embodiments described is merely a part of the embodiments of the present application, rather than all of them. Based on the embodiments of the present application, all the other embodiments obtained by those of ordinary skill in the art without any creative effort will fall into the protection scope of the present application.

### Embodiment 1

The present embodiment provides a time-based file push notification method, and description will be given with a file push notification device installed in a mobile phone as the executing subject.

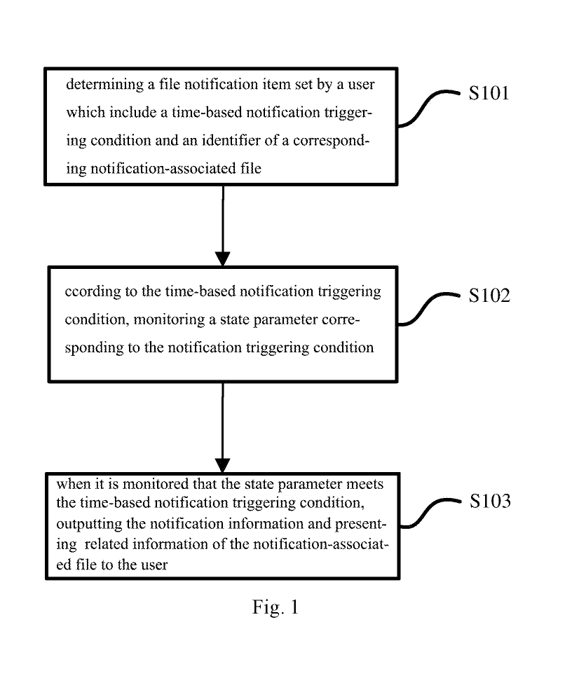

FIG. 1 is a flow chart of a time-based file push notification method of the present application, which essentially comprises the following steps:

S101, determining a file notification item set by a user which include a time-based notification triggering condition and an identifier of a corresponding notification-associated file.

In this step, the user firstly needs to store a notification-associated file beforehand in a mobile phone locally or in a network server, and this file is the one that the user requires the mobile phone to remind him/her to view at some time.

For example, the user has a dinner party at 18:00, and in order to avoid forgetting it, the user records the contents such as the time, place, notes or the like in a file named “dinner party” and stores it in the mobile phone locally or in a network server; the file push notification device needs to remind the user at 17:00 and present to the user the content of “dinner party” for the user to view.

Firstly, the user needs to set the related file notification item, such as to choose time as the notification triggering condition, and to choose to be reminded at 17:00. If the file is stored in the mobile phone locally, the identifier of the notification-associated file may be: name “dinner party”, or may also be other identifiers, of course.

If the user stores the notification-associated file in a server, for example, the user stores the file “dinner party” in his/her own network hard disk, then the identifier of the notification-associated file input by the user may be the corresponding network link or a file list of the network hard disk viewed by a file manager.

Moreover, if a user needs to view a plurality of files and the files are in the same folder, then the identifier of the notification-associated file may be the name of the folder or the respective names of the files or may also be the respective network links of the files.

After the user has input these conditions, the file push notification device determines these file notification items set by the user, and the notification function is activated.

S102, according to the time-based notification triggering condition, monitoring a state parameter corresponding to the notification triggering condition.

After the notification function is activated, the file push notification device will monitor whether the current time is consistent with the time 17:00 input by the user. Detailed implementations of this step may be realized with relevant solutions of the prior art, which will not be described here repeatedly.

S103, when it is monitored that the state parameter meets the time-based notification triggering condition, outputting the notification information and presenting related information of the notification-associated file to the user.

When the file push notification device monitors that the current time is 17:00, then it will remind the user in a vibration manner and find the file “dinner party”, and open it for the user to view.

It should be understood that, in addition to vibration information, the notification information may also be acoustic information such as a ring tone, or screen lighting information or notification information presented in a notification area of an operating system, etc. When there are various kinds of notification information, the file push notification device may automatically monitor the current usage state of the mobile phone and automatically select a type of notification information. For example, when it is monitored that the mobile phone is currently in a phone call, the device will output vibration notification information, otherwise, it will output a ring tone; of course, the type of notification information may also be set by the user.

It should be noted that the notification information may be output separately or may be output in a combination of various kinds of notification information.

Similarly, the related information of presenting the notification-associated file could not only be the content of the file, but also be corresponding access methods of the file such as a local path or a network link, and the file push notification device may automatically choose a way to present.

For example, if the notification-associated file to be presented is a file in the mobile phone, when it is monitored that the state parameter meets the time-based notification triggering condition, the notification information will be output and the file push notification device may automatically choose to present the content of the notification-associated file.

If there are a plurality of notification-associated files to be presented, when it is monitored that the state parameter meets the time-based notification triggering condition, the notification information will be output and the file push notification device may automatically choose to present a list of access methods of the notification-associated files, which may be a list of local paths or a list of network link of the files.

It should be noted that, sometimes the file to be viewed by the user is relatively large and it takes much time to open these files. At this time, in step S101 of the present embodiment, the user can set to open the file in advance at a time before outputting the notification information such that the user will not need to take time to wait for the opening of the file any more when he/she receives a notification to view the file.

### Embodiment 2

The present embodiment provides a geographical location-based file push notification method; descriptions will be given with a file push notification device installed in a mobile phone as the executing subject.

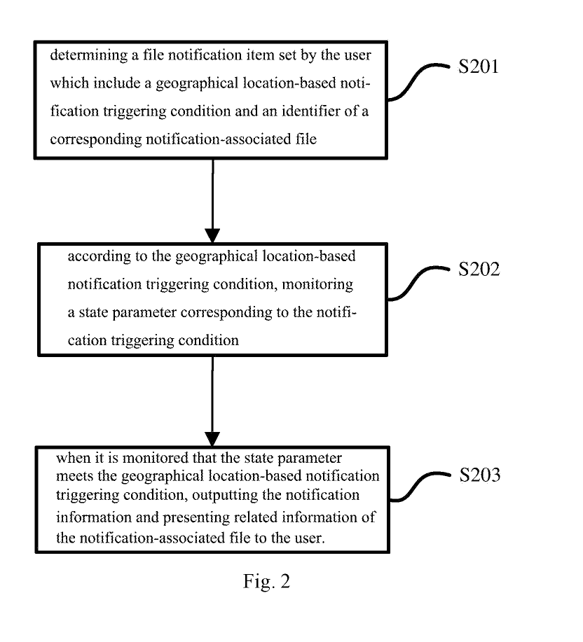

FIG. 2 shows a flow chart of a geography-based file push notification method of the present application, which essentially comprises the following steps:

S201, determining a file notification item set by the user which include a geographical location-based notification triggering condition and an identifier of a corresponding notification-associated file.

The implementation of this step is identical with that of the Embodiment 1 except the notification triggering condition. In this embodiment, the notification triggering condition chosen by the user is a geographical location, which is a target location.

For example, the user needs to read a shopping list when arriving at a supermarket to confirm the goods to be purchased. Therefore, the user chooses the geographical location of the supermarket as the notification triggering condition.

It can be understood that, besides the geographical coordinate of the target location, the user may also input a text description of the target location, such as “XX supermarket”, “XX building”, and one may also click the target location in the Map application directly; one skilled in the art may determine the specific implementation based on practical circumstances.

Usually, what is input by the user is a specific target location, and the file push notification device will remind the user automatically when the current location is within a region around the target location, wherein the size of the region may be determined by one skilled in the art according to practical circumstances. In this embodiment, the file push notification device starts to remind the user when he/she is 20 meters from the supermarket.

After the user has input these conditions, the file push notification device determines these file notification items set by the user and the notification function is activated.

S202, according to the geographical location-based notification triggering condition, monitoring a state parameter corresponding to the notification triggering condition.

After the notification function is activated, the file push notification device will monitor in real time whether the current geographical location is in the range of 20 meters from the supermarket.

Detailed implementation of this step may be realized with relevant solutions in the prior art, which will not be described here repeatedly.

S203, when it is monitored that the state parameter meets the geographical location-based notification triggering condition, outputting the notification information and presenting related information of the notification-associated file to the user.

When the file push notification device monitors that the current geographical location is just 20 meters from the supermarket, it outputs the notification information and presents the related information of the notification-associated file to the user. The specific implementation thereof is identical with that in the Embodiment 1 and it will not be described here repeatedly.

Similarly, sometimes the file to be viewed by the user is relatively large and it takes much time to open these files. At this time, in step S201 of the present embodiment, the user can also set to open the files in advance in a region around the set target geographical location such that the user will not need to take time to wait for the opening of the file any more when he/she receives a notification to view the file.

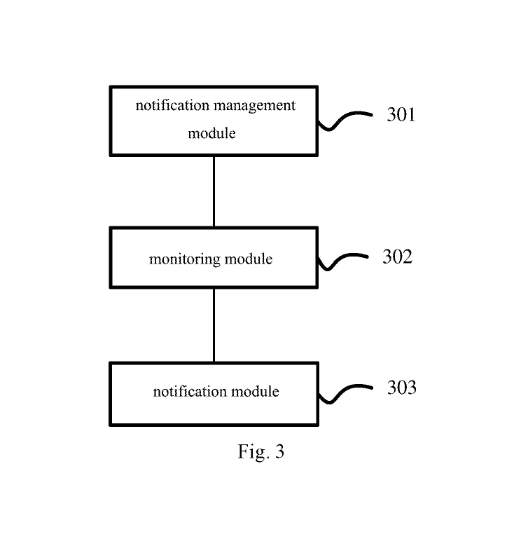

Corresponding to the above embodiments of the method, the present application also provides a file push notification device as shown in FIG. 3, which may comprise:

a notification management module 301 used to determine a file notification item set by a user which include a notification triggering condition as well as an identifier of a corresponding notification-associated file;

a monitoring module 302 used to monitor a state parameter corresponding to the notification triggering condition according to the notification triggering condition;

a notification module 303 used to output notification information and present an access method of the notification-associated file to the user when the monitoring module monitors that the state parameter meets the notification triggering condition.

In a specific implementation of the present application, the notification module 303 is specifically used to:

output notification information and present content of the notification-associated file to the user when the monitoring module 302 monitors that the state parameter meets the notification triggering condition;

or

output notification information and present an access method of the notification-associated file to the user when the monitoring module 302 monitors that the state parameter meets the notification triggering condition;

wherein, in the case that there are a plurality of notification-associated files to be presented, the notification module 303 is specifically used to:

output notification information and present a list of access methods of the notification-associated files to the user when the monitoring module 302 monitors that the state parameter meets the notification triggering condition.

In a specific implementation of the present application, the notification information output by the notification module 303 is vibration information and/or acoustic information.

In a specific implementation of the present application, the notification triggering condition is a geographical location-based triggering condition or a time-based triggering condition.

Embodiments of a device or a system are simply described since they are essentially similar to embodiments of a method, and the related parts could refer to the parts of the description of embodiments of a method. The embodiments of a device and a system described above is merely illustrative, wherein the modules described as separate parts may be physically separated or not, and one may choose a part or all of the modules to realize the objectives of the solutions of the present embodiment according to practical needs. One skilled in the art may understand and implement it without any creative effort.

Moreover, the embodiments of the present application also provide an electronic device which may comprise:

a processor, a memory, communication interfaces and a bus;

the processor, the memory, and the communication interfaces are connected and communicating with each other via the bus;

executable program codes are stored in the memory;

The processor runs the program corresponding to the executable program codes by reading the executable program codes stored in the memory, so as to carry out the file push notification method provided by the embodiments of the present application; wherein, the file push notification method provided by the embodiment of the present application may comprise:

determining a file notification item set by a user which comprise a notification triggering condition and an identifier of a corresponding notification-associated file;

according to the notification triggering condition, monitoring a state parameter corresponding to the notification triggering condition;

when it is monitored that the state parameter meets the notification triggering condition, outputting notification information and presenting related information of the notification-associated file to the user.

Here, the step of presenting related information of the notification-associated file to the user comprises:

presenting content of the notification-associated file to the user directly;

or

presenting an access method of the notification-associated file to the user.

In a specific implementation of the present application, in the case that there are a plurality of notification-associated files, the step of presenting related information of the notification-associated files to the user comprises:

presenting a list of access methods of the plurality of notification-associated files to the user.

In a specific implementation of the present application, the step of outputting notification information is: outputting at least one of vibration information, acoustic information, screen lighting information and notification information presented in a notification area of an operating system.

In a specific implementation of the present application, the notification triggering condition is a geographical location-based triggering condition or a time-based triggering condition.

Moreover, embodiments of the present application also provide a storage medium used for storing an application program for carrying out the file push notification method provided by the embodiments of the present application; wherein, the file push notification method provided by the embodiments of the present application may comprise:

determining a file notification item set by a user which comprise a notification triggering condition and an identifier of a corresponding notification-associated file;

according to the notification triggering condition, monitoring a state parameter corresponding to the notification triggering condition;

when it is monitored that the state parameter meets the notification triggering condition, outputting notification information and presenting related information of the notification-associated file to the user.

Here, the step of presenting related information of the notification-associated file to the user comprises:

presenting content of the notification associated file to the user directly;

or

presenting an access method of the notification-associated file to the user.

In a specific implementation of the present application, in the case that there are a plurality of notification-associated files, the step of presenting related information of the notification-associated files to the user comprises:

presenting a list of access methods of the plurality of notification-associated files to the user.

In a specific implementation of the present application, the step of outputting notification information is: outputting at least one of vibration information, acoustic information, screen lighting information and notification information presented in a notification area of an operating system.

In a specific implementation of the present application, the notification triggering condition is a geographical location-based triggering condition or a time-based triggering condition.

Moreover, the embodiments of present application also provide an application program for carrying out the file push notification method provided by the embodiments of the present application; wherein, the file push notification method provided by the embodiments of the present application may comprise:

determining a file notification item set by a user which comprise a notification triggering condition and an identifier of a corresponding notification-associated file;

according to the notification triggering condition, monitoring a state parameter corresponding to the notification triggering condition;

when it is monitored that the state parameter meets the notification triggering condition, outputting notification information and presenting related information of the notification-associated file to the user.

Here, the step of presenting related information of the notification-associated file to the user comprises:

presenting content of the notification associated file to the user directly;

or

presenting an access method of the notification-associated file to the user.

In a specific implementation of the present application, in the case that there are a plurality of notification-associated files, the step of presenting related information of the notification-associated files to the user comprises:

presenting a list of access methods of the plurality of notification-associated files to the user.

In a specific implementation of the present application, the step of outputting notification information is: outputting at least one of vibration information, acoustic information, screen lighting information and notification information presented in a notification area of an operating system.

In a specific implementation of the present application, the notification triggering condition is a geographical location-based triggering condition or a time-based triggering condition.

The description above is merely the preferred embodiments of the present application and not intended to limit the present application, and any modifications, equivalent replacements and improvements made within the spirit and principle of the present application should be included in the protection scope of the present application.

1. A file push notification method, characterized in that the method comprises:
determining a file notification item set by a user which comprise a notification triggering condition and an identifier of a corresponding notification-associated file;
according to the notification triggering condition, monitoring a state parameter corresponding to the notification triggering condition;
when it is monitored that the state parameter meets the notification triggering condition, outputting notification information and presenting related information of the notification-associated file to the user.

2. The method according to claim 1, characterized in that, the step of presenting related information of the notification-associated file to the user comprises:
presenting content of the notification associated file to the user directly; or
presenting an access method of the notification-associated file to the user.

3. The method according to claim 2, characterized in that, in case that there are a plurality of notification-associated files, the step of presenting related information of the notification-associated files to the user comprises:
presenting a list of access methods of the plurality of the notification-associated files to the user.

4. The method according to claim 1, characterized in that, the step of outputting notification information is: outputting at least one of vibration information, acoustic information, screen lighting information and notification information presented in a notification area of an operating system.

5. The method according to claim 1, characterized in that, the notification triggering condition is a geographical location-based triggering condition or a time-based triggering condition.

6. A file push notification device, characterized in that the device comprises:
a notification management module used to determine a file notification item set by a user which comprise a notification triggering condition as well as an identifier of a corresponding notification-associated file;
a monitoring module used to monitor a state parameter corresponding to the notification triggering condition according to the notification triggering condition;
a notification module used to output notification information and present related information of the notification-associated file to the user when the monitoring module monitors that the state parameter meets the notification triggering condition.

7. The device according to claim 6, characterized in that, the notification module is specifically used to:
output notification information and present content of the notification-associated file to the user when the monitoring module monitors that the state parameter meets the notification triggering condition ; or
output notification information and present an access method of the notification-associated file to the user when the monitoring module monitors that the state parameter meets the notification triggering condition.

8. The device according to claim 7, characterized in that, in case that there are a plurality of notification-associated files, the notification module is specifically used to:
output notification information and present a list of access methods of the plurality of notification-associated files to the user when the monitoring module monitors that the state parameter meets the notification triggering condition.

9. The device according to claim 6, characterized in that, the notification information output by the notification module is at least one of vibration information, acoustic information, screen lighting information and notification information presented in a notification area of an operating system.

10. The device according to claim 6, characterized in that, the notification triggering condition is a geographical location-based triggering condition or a time-based triggering condition.

11. An electronic device, characterized in that it includes:
a processor, a memory, communication interfaces and a bus;
the processor, the memory, and the communication interfaces are connected and communicating with each other via the bus;
executable program codes are stored in the memory;
the processor runs a program corresponding to the executable program codes by reading executable program codes stored in the memory, so as to execute the file push notification method according to claim 1.

12. A storage medium, characterized in that it is used for storing an application program, the application program being used to carry out the file push notification method according to claim 1.

13. An application program, characterized in that, it is used to carry out the file push notification method according to claim 1.
